(19) United States
(12) Patent Application Publication
(10) Pub. No.: US 2012/0159508 A1
(43) Pub. Date: Jun. 21, 2012

(54) TASK MANAGEMENT SYSTEM, TASK MANAGEMENT METHOD, AND PROGRAM

(76) Inventors: Masanobu KATAGI, Kanagawa (JP); Atsushi OKAMORI, Tokyo (JP); Masakazu UKITA, Kanagawa (JP); Shiho MORIAI, Kanagawa (JP)

(21) Appl. No.: 13/313,476

(22) Filed: Dec. 7, 2011

(30) Foreign Application Priority Data
Dec. 15, 2010 (JP) P2010-279662

(51) Int. Cl. G06F 9/46; G06F 15/173

(52) U.S. Cl. 718/104

(57) ABSTRACT

A task management system includes a capacity information acquisition section which acquires, from a computation device which executes a computation using electrical power derived from renewable energy, capacity information which shows the computation capacity of the computation device which is predicted based on weather information of a region where the computation device is disposed, and a task management section which allocates a computation task to a plurality of the computation devices based on the capacity information which is acquired from the plurality of computation devices using the capacity information acquisition section.

### BACKGROUND

The present disclosure relates to a task management system, a task management method, and a program.

Among the clamor about the limits of non-renewable energy resources such as oil, coal and the like, there is a large focus on generating power using renewable energy from the sunlight, wind, and the like. For example, in order to replace power plants which generate power using non-renewable energy, solar power plants which generate power using sunlight, wind power plants which generate power using wind, and the like are being built in each region. In addition, accompanying an increase in interest from typical citizens in relation to the protection of the natural environment, power generating facilities such as solar power generating facilities are also coming into wide spread use in typical households. Furthermore, there is interest in various methods for using renewable energy such as methods for effectively using renewable energy (for example, refer to Japanese Unexamined Patent Application Publication No. 2010-255963) and methods for effectively using electrical power which is derived from renewable energy (for example, refer to Japanese Unexamined Patent Application Publication No. 2010-119225).

### SUMMARY

However, the supply amount of renewable energy often varies according to the weather conditions. For example, the hours of sunshine are short on rainy days. In addition, wind power is substantially zero on still days. In these weather conditions, hardly any electrical power is able to be obtained using solar power plants or wind power plants. In this case, it is necessary that the operation of electronic apparatuses, which operate using electrical power which is derived from renewable energy, is terminated. In addition, even if the operation is not completely terminated, since the supply amount of electrical power is small, it is considered that the processing capacity of electronic apparatuses is reduced. In this manner, in the electronic apparatuses which operate using electrical power derived from renewable energy, the termination of operation or reduction in processing performance capacity may occur at an unpredictable timing.

As a result, when using an electronic apparatus such as this, it is necessary that a process is executed in the electronic apparatus at a timing when it is possible to reliably complete a process which is to be executed. Here, a system will be considered which realizes a distributed computing using a plurality of computation devices which operate using electrical power derived from renewable energy. The termination of operation or reduction in processing performance capacity may occur in each of the computation devices which are included in this system at a timing which is not predicted in the same manner as the electronic apparatuses described above. However, if the termination of operation or reduction in processing performance occurs in a portion of the computation devices, the performance of the entire system is significantly reduced. In order that the reduction in performance does not occur, it is necessary to design a method where the computation tasks are allocated according to the computation capacity of each of the computation devices during the execution of computations.

Therefore, it is desirable to provide a new and improved task management system, a task management method, and a program which are able to allocate appropriate computation tasks in consideration of computation capacity during the execution of computations in a computation device which executes computations using electrical power derived from renewable energy. Here, computation capacity referred to here has, for example, the meaning of a computation amount which is able to be completed using electrical power derived from renewable energy in a predetermined period of time from a point in time where the execution of the computation tasks is requested.

A task management system according to an embodiment of the disclosure includes: a capacity information acquisition section which acquires, from a computation device which executes a computation using electrical power derived from renewable energy, capacity information which shows the computation capacity of the computation device which is predicted based on weather information of a region where the computation device is disposed; and a task management section which allocates a computation task to a plurality of the computation devices based on the capacity information which is acquired from the plurality of computation devices using the capacity information acquisition section.

In addition, the task management system may further include: a computation capacity prediction section which predicts the computation capacity of the computation device based on weather information of the region where the computation device is disposed; and a computation capacity verification section which verifies the validity of the capacity information by comparing the computation capacity shown in the capacity information acquired by the capacity information acquisition section and the computation capacity predicted by the computation capacity prediction section. In this case, the task management section may allocate the computation task to the computation device which corresponds to the capacity information where the validity is confirmed by the computation capacity verification section.

In addition, a task management system according to another embodiment of the disclosure includes: a computation capacity prediction section which predicts computation capacity of a computation device which executes a computation using electrical power derived from renewable energy from weather information of a region where the computation device is disposed; and a task management section which allocates a computation task to a plurality of the computation devices based on the computation capacity which is predicted by the computation capacity prediction section with regard to the plurality of computation devices.

In addition, the task management system may further include: an execution request section which requests execution of the computation task with regard to the computation device which is allocated the computation task by the task management section; a result acquisition section which acquires an execution result of the computation task from the computation device which received the request for the computation task using the execution request section; and a dishonesty detection section which detects dishonesty in the execution result which is acquired by the result acquisition section based on information on the computation capacity which is predicted by the computation capacity prediction section.

In addition, the dishonesty detection section may be configured so as to determine that the execution result which is acquired by the result acquisition section is dishonest in a case where a time T1, which is necessary until the computation task is completed in a case where the computation task is executed at the computation capacity which is predicted using the computation capacity prediction section, and a time T2, which it has taken from the execution request using the execution request section until the execution result is acquired using the result acquisition section, are compared and T2<T1.

In addition, in a case where the computation device where the execution of the computation task is requested by the execution request section is connected to a storage battery, the dishonesty detection section may be configured so as to determine that the execution result which is acquired by the result acquisition section is dishonest in a case where a time T3, which is necessary until the computation task is completed in a case where the computation task is executed using the computation capacity of the computation device in a state where the storage battery is fully charged and the computation capacity which is predicted by the computation capacity prediction section, and a time T2 which it has taken from the execution request using the execution request section until the execution result is acquired using the result acquisition section, are compared and T2<T3.

In addition, a task management method of a task management system according to still another embodiment of the disclosure includes: acquiring, from a computation device which executes a computation using electrical power derived from renewable energy, capacity information which shows the computation capacity of the computation device which is predicted based on weather information of a region where the computation device is disposed; and allocating a computation task to a plurality of the computation devices based on the capacity information which is acquired from the plurality of computation devices using the capacity information acquisition section.

In addition, a task management method of a task management system according to still another embodiment of the disclosure includes: predicting computation capacity of a computation device which executes a computation using electrical power derived from renewable energy from weather information of a region where the computation device is disposed; and allocating a computation task to a plurality of the computation devices based on the computation capacity which is predicted with regard to the plurality of computation devices.

In addition, a program according to still another embodiment of the disclosure causes a computer to execute: a capacity information acquisition function which acquires, from a computation device which executes a computation using electrical power derived from renewable energy, capacity information which shows the computation capacity of the computation device which is predicted based on weather information of a region where the computation device is disposed; and a task management function which allocates a computation task to a plurality of the computation devices based on the capacity information which is acquired from the plurality of computation devices using the capacity information acquisition function.

In addition, a program according to still another embodiment of the disclosure causes a computer to execute: a computation capacity prediction function which predicts computation capacity of a computation device which executes a computation using electrical power derived from renewable energy from weather information of a region where the computation device is disposed; and a task management function which allocates a computation task to a plurality of the computation devices based on the computation capacity which is predicted by the computation capacity prediction function with regard to the plurality of computation devices.

In addition, a recording medium according to still another embodiment of the disclosure, which records the program and is able to be read by a computer, is provided.

According to the embodiments of the disclosure described above, it is possible to allocate appropriate computation tasks in consideration of computation capacity during the execution of computations in a computation device which executes computations using electrical power derived from renewable energy.

### BRIEF DESCRIPTION OF THE DRAWINGS

FIG. 1 is an explanatory diagram for describing a system configuration of a distribution processing system which uses renewable energy according to an embodiment of the disclosure;

FIG. 2 is an explanatory diagram for describing a functional configuration of a task management system which is included the distribution processing system according to the embodiment;

FIG. 3 is an explanatory diagram for describing a functional configuration of a computation device which is included the distribution processing system according to the embodiment;

FIG. 4 is an explanatory diagram for describing one example of a task allocation method according to the embodiment;

FIG. 5 is an explanatory diagram for describing one example of a task allocation method according to the embodiment;

FIG. 6 is an explanatory diagram for describing one example of a task allocation method according to the embodiment;

FIG. 7 is an explanatory diagram for describing a dishonesty verification method according to the embodiment;

FIG. 8 is an explanatory diagram for describing a method for predicting computation capacity according to the embodiment;

FIG. 9 is an explanatory diagram for describing a method for predicting computation capacity according to the embodiment;

FIG. 10 is an explanatory diagram for describing a method for predicting computation capacity according to the embodiment;

FIG. 11 is an explanatory diagram for specifically describing a dishonesty verification method according to the embodiment;

FIG. 12 is an explanatory diagram for specifically describing a dishonesty verification method according to the embodiment; and

FIG. 13 is an explanatory diagram for describing a hardware configuration of an information processing device which is able to realize the functions of the task management system and the computation device according to the embodiment.

### DETAILED DESCRIPTION OF EMBODIMENTS

Below, an embodiment of the disclosure will be described in detail while referencing the attached diagrams. Here, in the specifications and the diagrams, in regard to constituent elements which have the same functional configuration in practice, the same reference numerals are attached, and thus, overlapping description is omitted.

[Flow of Description]

Here, the flow of the description in relation to the embodiment of the disclosure which is described below will be simply described.

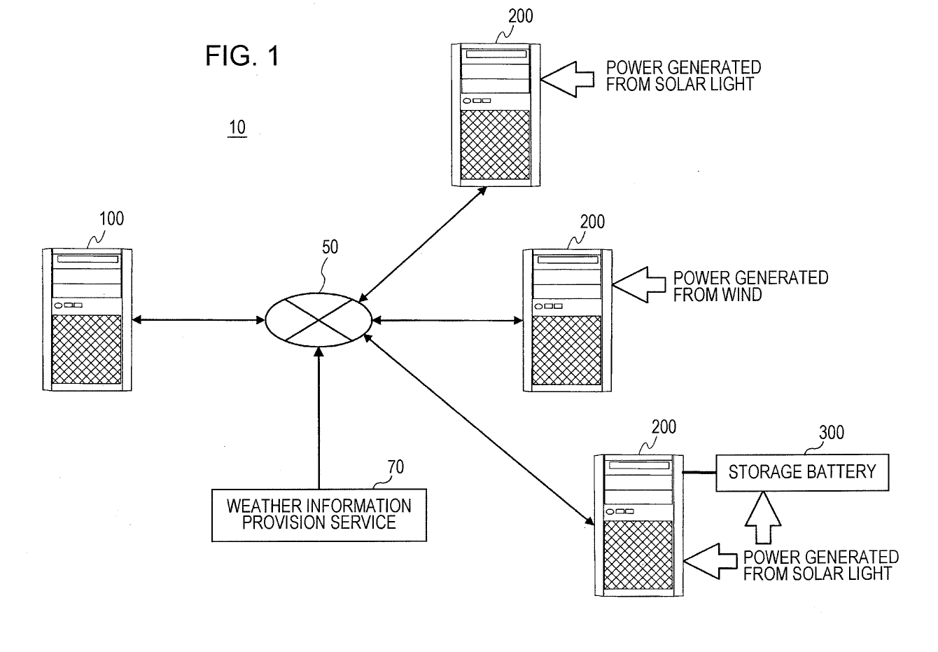

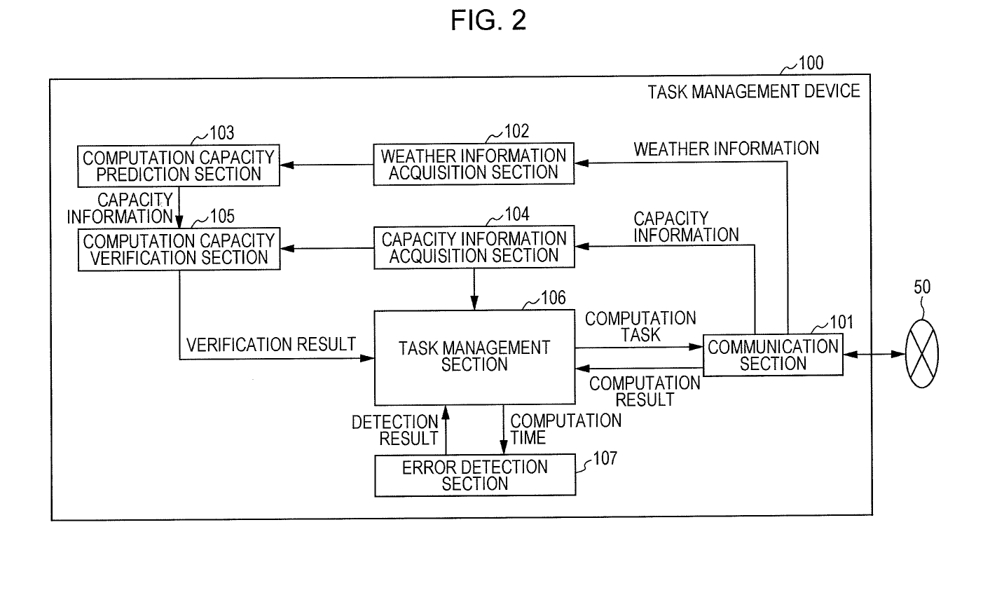

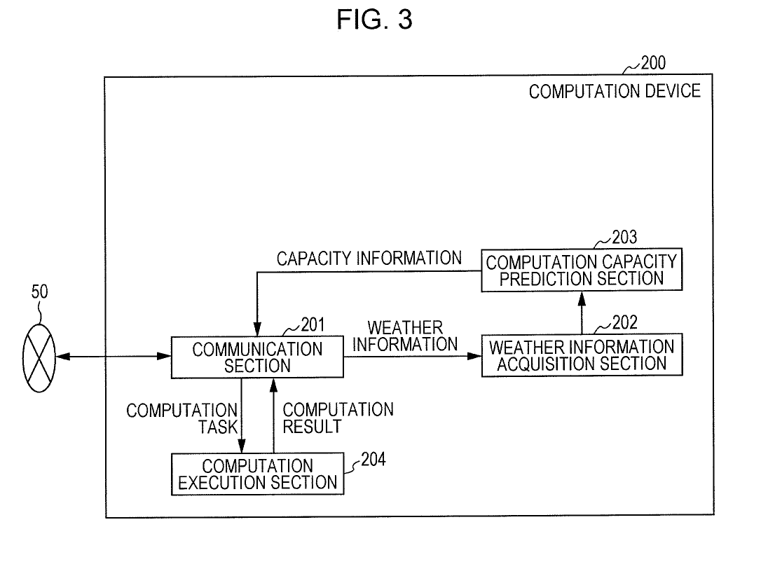

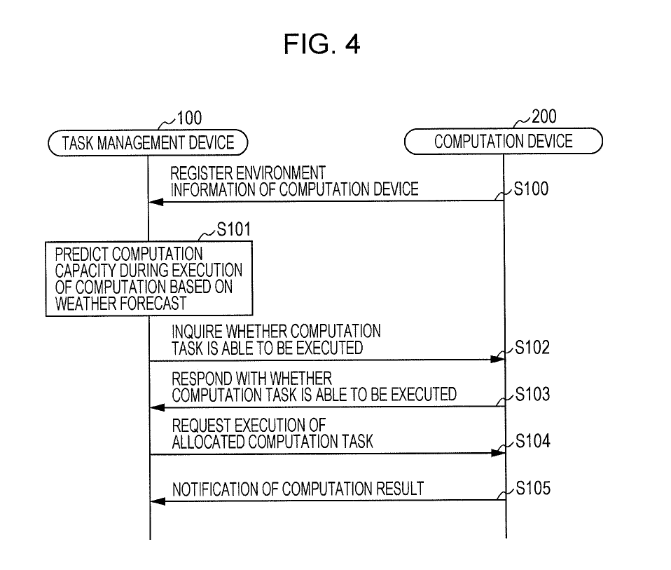

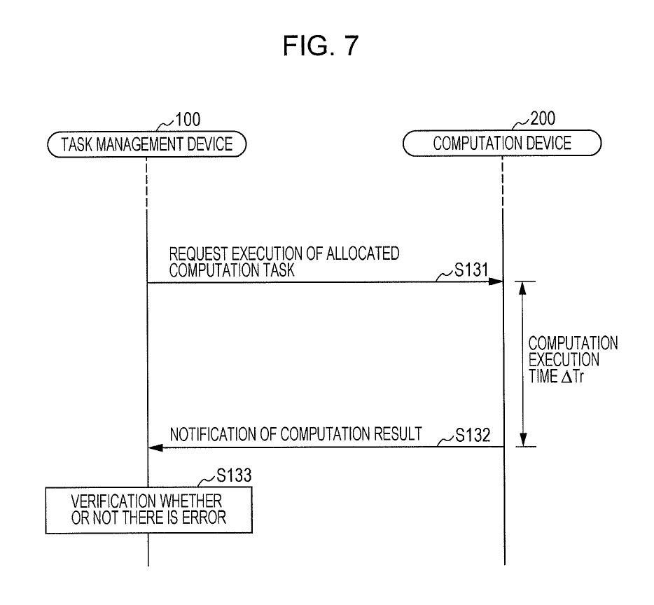

First, a system configuration of a distribution processing system 10 which uses renewable energy according to an embodiment will be described while referencing FIG. 1. Next, a functional configuration of a task management system 100 which is included the distribution processing system 10 will be described while referencing FIG. 2. Next, a functional configuration of a computation device 200 which is included the distribution processing system 10 according to the embodiment will be described while referencing FIG. 3. Next, a task allocation method according to the embodiment will be described while referencing FIGS. 4 to 6. Next, a dishonesty verification method according to the embodiment will be described while referencing FIG. 7.

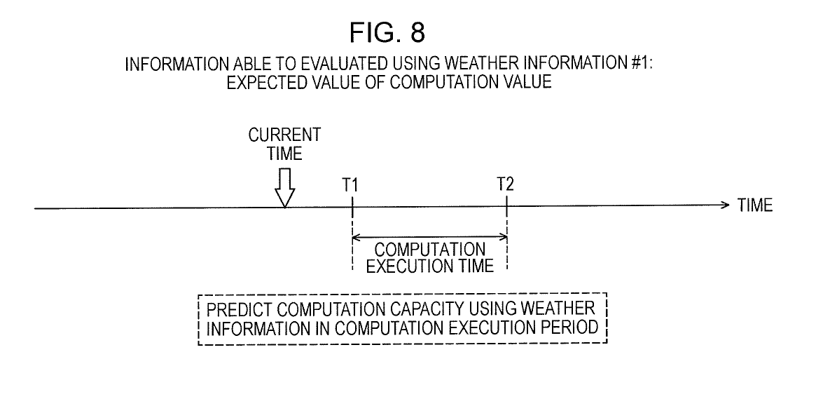

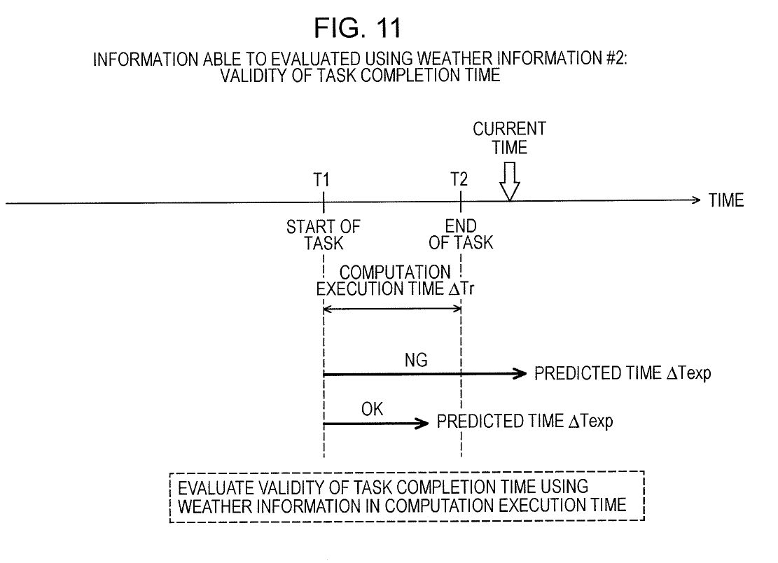

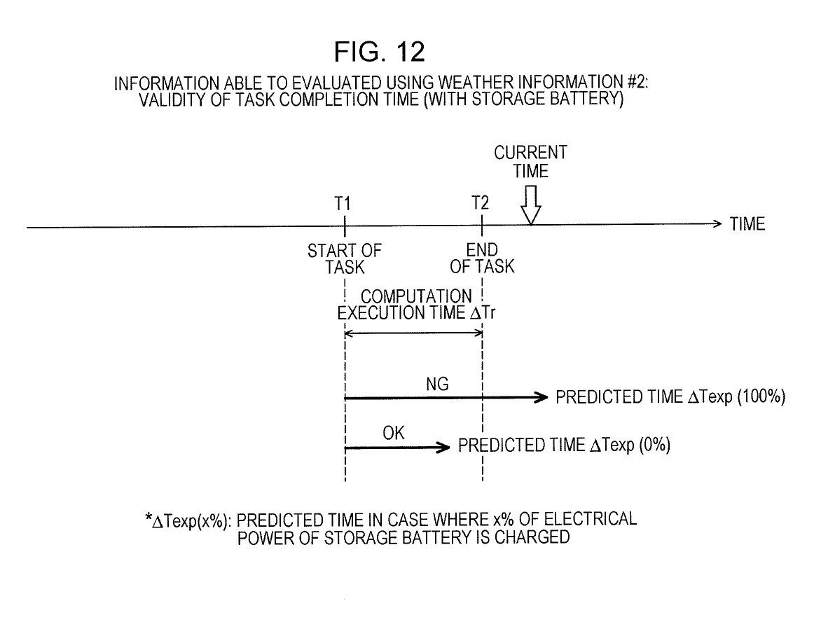

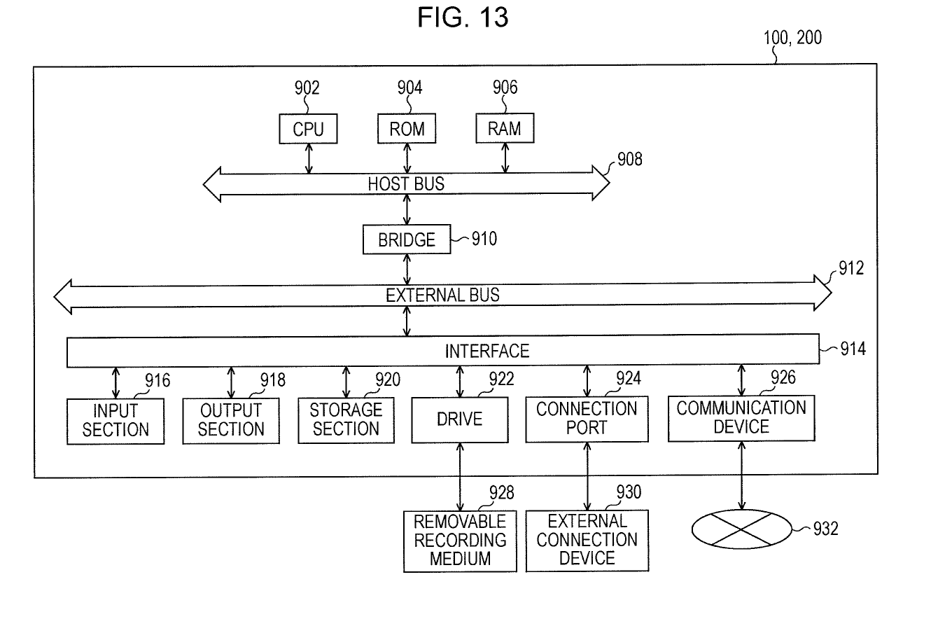

In addition, a method for predicting computation capacity according to the embodiment will be described while referencing FIGS. 8 to 10. Furthermore, a dishonesty verification method according to the embodiment will be specifically described while referencing FIGS. 11 and 12. Next, a hardware configuration of an information processing device which is able to realize the functions of the task management system 100 and the computation device 200 according to the embodiment will be described while referencing FIG. 13. Finally, the technical concept of the embodiment will be summarized and operational effects which are able to be obtained from the technical concept will be simply described.

(Description Items)

1. Embodiment

1-1: System Configuration of Distribution Processing System 10

1-2: Functional Configuration of Task Management system 100

1-3: Functional Configuration of Computation Device 200

1-4: Task Allocation Method

1-4-1: Case where Computation Capacity is Predicted using Task Management system 100

1-4-2: Case where Computation Capacity is Predicted using Computation Device 200

1-4-3: Case where Computation Capacity is Verified

1-5: Dishonesty Verification Method

1-6: Hardware Configuration Example

2. Summary

### 1. Embodiment

An embodiment of the disclosure will be described.

[1-1: System Configuration of Distribution Processing System 10]

First, a system configuration of the distribution processing system 10 will be described while referencing FIG. 1. FIG. 1 is an explanatory diagram for describing a system configuration of the distribution processing system 10 according to the embodiment.

As shown in FIG. 1, the distribution processing system 10 is configured by a task management system 100 and a plurality of computation devices 200. Here, the task management system 100 and the plurality of computation devices 200 are connected via a network 50. In addition, the network 50 is connected to a provider of a weather information provision service 70. Here, in the example in FIG. 1, there are three computation devices 200, but the number of computation devices 200 may be two or may be four or more.

The distribution processing system 10 is a system which divides and allocates a plurality of computation tasks to the plurality of computation devices 200 and executes the plurality of computation tasks in parallel. The process of allocating the computation tasks is executed by the task management system 100. In addition, the computation device 200 according to the embodiment operates using electrical power derived from renewable energy. For example, the computation device 200 operates using electrical power which is generated using solar power generation or wind power generation. In addition, the computation device 200 may be connected to a storage battery 300. In this case, the computation device 200 operates using electrical power which is stored in the storage battery 300 and electrical power derived from renewable energy.

Typically, dispersion processing technology where a plurality of computation tasks are distributed to and executed by a plurality of computers is used in various fields. For example, distribution processing technology is used in large-scale calculations such as molecular dynamics calculations, weather prediction calculations, and the like. In particular, there is a large interest in a technology referred to as grid computing where computation tasks are executed in parallel by using computers disposed in a plurality of locations. However, considerable electrical power is necessary in operating the plurality of computers. In addition, large-scale air conditioning equipment and the like is operated for cooling the computers in a data center or the like where high-performance computers are gathered together and electrical power consumed for executing a certain amount of computations is enormous.

As a result, in a case where the effects of global warming are considered, it is desirable if the electrical power consumed for executing a certain amount of computations is provided by electrical power derived from renewable energy, consumption of non-renewable energy is suppressed, and the release of gases which have a warming effect are suppressed as much as possible. That is, it may be said that the realization of large-scale calculations which are “environmentally friendly” by the grouping of computers which operating using electrical power derived from renewable energy is one issue to be dealt with by modern society. The distribution processing system 10 according to the embodiment is proposed for this reason. However, the supply amount of electrical power derived from renewable energy is unstable. For example, the supply amount of electrical power which is able to be obtained using solar power generation varies depending on the daylight conditions.

As a result, in a case where renewable energy is used, a unique task allocation method is necessary which is different from task allocation methods which are used in typical distribution computing. In addition, it is also desirable to design the disposition of the locations where the computers are disposed in order to relieve the instability of the electrical power supply amount. For example, when all of the computers are disposed in the same location, in a case where the weather conditions at that location deteriorate, it is necessary that all of the computers are stopped. In order to reduce this risk, it is desirable to dispose the computers which carry out distribution processing in locations which are geographically separated.

However, even with a design such as this, computations are delayed when there is deterioration in the weather condition which is not able to be predicted at a location where there are computers which are allocated a computation task and the computers in the location where the weather conditions have deteriorated have been allocated a computation task. In the case of dispersion computing, when a portion of a computation task is not completed, it is not possible to obtain a final computation result. As a result, when a portion of a computation task is not completed, there is a process where the computation task which was not completed is reallocated to another computer or a delay is permitted and the completion of the computation task is waited for. As a result, the performance of the entire system is remarkably reduced.

In order to avoid such a situation, it is sufficient if the computers are operated using electrical power which is stored in a large-scale storage unit in an auxiliary manner or using electrical power which is supplied from an electrical power company in an auxiliary manner. However, if a method such as this is adopted, there are extra costs such as costs in providing the storage unit, costs in receiving a supply of electrical power from the electrical power company, and the like. When there are extra costs such as these, since the computation cost per unit of computation is increased, generation of extra costs is to be suppressed as much as possible.

Considering these conditions, the present inventors propose an arrangement where computers which are able to complete a computation task in a predetermined time from a computation execution start time are detected by predicting the supply amount of renewable energy and the computation task is allocated to that computer. The distribution processing system 10 shown in FIG. 1 is one example of this. A unit which allocates the computation tasks in the distribution processing system 10 is the task management system 100. On the other hand, the unit which executes the computation task is the computation device 200. Here, as shown in FIG. 1, the computation device 200 may be connected to the storage unit (the storage battery 300). In this case, there is the cost of providing the storage battery 300, but it is possible to further stabilize the supply of electrical power by storing surplus electrical power in the storage battery 300 and using the surplus power when there is insufficient electrical power.

As will be described in detail later, the task management system 100 according to the embodiment predicts the computation capacity of each computation device 200 using weather information and allocates a computation task to each computation device 200 based on the prediction result. The computation capacity refer to here has the meaning of a computation amount which the computation device 200 which is the target is able to complete in a predetermined time. For example, in a case where the execution of a computation task is started by the computation device 200 at a timing T1, the computation amount X which is able to be completed by a timing T2 (T2>T1) is equivalent to the computation capacity of the computation device 200. In addition, the computation capacity may be expressed by a time necessary until a computation task is completed. For example, in a case where the execution of a computation task with a computation amount X is started by the computation device 200 at a timing T1, the time ΔT until the computation task is completed (or a timing T2 when the computation task is completed) is equivalent to the computation capacity of the computation device 200.

The computation capacity described above depends on the computation amount which is able to be executed per unit of time by the computation device 200 which is the target. In addition, since the computation amount which is able to be executed per unit of time decreases when the amount of electrical power supplied to the computation device 200 is small, the computation capacity also depends on the amount of electrical power which is supplied to the computation device 200. If it is assumed that the computation amount, which is able to be executed per unit of time by the computation device 200 in a case where electrical power which is an electrical power amount P is supplied, is constant, it is possible to determine the computation capacity of the computation device 200 based on the electrical power amount P supplied to the computation device 200. That is, if it is possible to know the relationship between the computation amount which is able to be executed per unit of time by the computation device 200 and the electrical power amount P, it is possible to predict the computation performance of the computation device 200 from a prediction value of the electrical power amount P.

In addition, the electrical power supplied to the computation device 200 is electrical power derived from renewable energy. As a result, it is possible to predict the electrical power amount P which is supplied to the computation device 200 based on weather information. For example, when considering the electrical power amount P which is generated using solar power generation, it is possible to estimate the electrical power amount P which is generated using solar power generation if the performance of solar panels and the daylight conditions (for example, daylight time, amount of direct solar radiation, and the like) are known. In addition, when considering the electrical power amount P which is generated using wind power generation, it is possible to estimate the electrical power amount P which is generated using wind power generation if the performance of wind-power generators and the wind conditions (for example, wind direction, amount of wind, and the like) are known. That is, it is possible to estimate the electrical power amount P which is supplied to the computation device 200 by referencing weather information of the region where the computation device 200 is disposed.

In this manner, it is possible to estimate the electrical power amount P which is supplied to the computation device 200 based on weather information. In addition, it is possible to predict the computation performance of the computation device 200 from the electrical power amount P. Accordingly, it is possible to predict the computation performance of the computation device 200 based on weather information. For example, by referencing a weather forecast after the timing when the execution of the computation task is scheduled to start, it is possible to predict the computation performance of the computation device 200 where the execution of a computation task is to be requested based on the electrical power amount P which is estimated from the weather forecast. Here, it is possible to acquire weather information, for example, from the weather information provision service 70 via the network 50.

The computation performance of the computation device 200 which is predicted as described above is used in task allocation by the task management system 100. For example, the task management system 100 selects the computation device 200 which is able to complete a computation task in a predetermined time by considering the predicted computation performance of each of the computation devices 200. Then, the task management system 100 allocates the computation task to the selected computation device 200. Using a configuration such as this, the task management system 100 can realize appropriate allocation of computation tasks in consideration of the computation performance of the computation devices 200 which changes according to changes in weather conditions.

However, the task management system 100 and the computation devices 200 which are included in the distribution processing system 10 may not be managed by the same manager. For example, a case may be considered where a manager of the task management system 100 requests the execution of the computation tasks by paying compensation to the manager of the computation device 200. In a case such as this, the compensation with regard to the execution of the computation task is calculated based on, for example, the computation amount, the execution time, or the like. That is, the compensation is paid irrespective of the accuracy of the computation result. If the manager of the computation device 200 has negative intentions, the computation task may be contracted out irrespective of computation capacity and a haphazard computation result may be returned to the task management system 100.

When there is dishonesty such as this carried out, the manager of the task management system 100 is not able to obtain a correct computation result even after paying a price for the dishonesty. Therefore, the present inventors propose an arrangement where the dishonesty such as that above is verified using a function where the computation capacity of the computation device 200 is predicted. This arrangement is realized using a function of the task management system 100. For example, in a case where execution of a computation task is requested to a certain computation device 200, the time which is necessary to execute the computation task is able to be predicted based on the computation capacity of the computation device 200 and the computation amount of the computation task. Therefore, the task management system 100 considers the computation result to be dishonest in a case where the computation result is returned in a time which is shorter than the predicted time.

In addition, in the following computation allocation process, the task management system 100 does not allocate a computation task to the computation device 200 which has returned a dishonest computation result. Due to a configuration such as this, it is possible for the manager of the task management system 100 to reduce the chances of paying a price for dishonesty. Here, before the execution of a computation task is requested to the computation device 200, it is possible to detect dishonesty by the manager of the computation device 200 from the contracting situation of the computation task of the computation device 200 in question and the computation capacity of the computation device 200 in question. In this case, it is possible to escape from paying a price for dishonesty by not requesting the execution of the computation task with regard to the computation device 200 in question.

Above, the system configuration of the distribution processing system 10 according to the embodiment was described. In addition, the operation of the task management system 100 and the computation device 200 which are included in the distribution processing system 10 will be simply described. Below, the functional configuration and operation of the task management system 100 and the computation device 200 will be described in detail.

[1-2: Functional Configuration of Task Management System 100]

First, the functional configuration of the task management system 100 will be described while referencing FIG. 2. FIG. 2 is an explanatory diagram for describing the functional configuration of the task management system 100. Here, the functional configuration of the task management system 100 shown in FIG. 2 is one example and appropriate omissions and modifications of a portion of the constituent elements are possible in regard to the method of allocating a computation task which will be described later.

As shown in FIG. 2, the task management system 100 is mainly configured by a communication section 101, a weather information acquisition section 102, a computation capacity prediction section 103, a capacity information acquisition section 104, a computation capacity verification section 105, a task management section 106, and a dishonesty detection section 107.

The communication section 101 is a communication unit for communicating via the network 50. In a case where a computation task is requested to the computation device 200, first, the weather information acquisition section 102 acquires weather information from the weather information provision service 70 via the communication section 101. At this time, the weather information acquisition section 102 acquires weather information of a region where the computation device 200 which is the target of the computation task request is disposed. In addition, the weather information acquisition section 102 acquires weather information which includes a weather forecast from at least after the timing when the execution of the computation task is scheduled to start. The weather information which is acquired by the weather information acquisition section 102 is input into the computation capacity prediction section 103.

When the weather information is input, the computation capacity prediction section 103 predicts the computation capacity of the computation device 200 which is the target of the computation task request. Here, the computation capacity prediction section 103 already holds information such as that related to the computation amount which is able to be executed per unit of time by the computation device 200 which is the target of the computation task request using the electrical power of the electrical power amount P (below, computation performance information). Furthermore, the computation capacity prediction section 103 already holds information related to generation performance of a power generator (power generator which generates electrical power derived from renewable energy) for supplying electrical power to the computation device 200 which is the target of the computation task request (below, generation performance information).

The computation capacity prediction section 103 predicts the electrical power amount P which is supplied with regard to the computation device 200 in a computation task execution scheduling period using the weather information and the generation performance information and predicts the computation capacity using the prediction result and the computation performance information. In this manner, the information which shows the computation performance which is predicted using the computation capacity prediction section 103 (below, capacity information) is input into the computation capacity verification section 105. In addition, the computation capacity verification section 105 inputs the capacity information which shows the computation performance of the computation device 200 which is acquired by the capacity information acquisition section 104. The capacity information is capacity information which is predicted based on the weather information using the computation device 200.

The description goes back and forth but the capacity information acquisition section 104 acquires the capacity information from the computation device 200 which is the target of the computation task request via the communication section 101. At this time, the capacity information acquisition section 104 inquiries about the computation performance in the computation task execution scheduling period with regard to the computation device 200 which is the target of the computation task request and acquires the capacity information which shows the computation performance. In this manner, the capacity information which is acquired using the capacity information acquisition section 104 is input into the computation capacity verification section 105 as described above. In addition, the capacity information is also input into the task management section 106.

The computation capacity verification section 105 compares the capacity information which is input by the computation capacity prediction section 103 and the capacity information which is input by the capacity information acquisition section 104 and verifies the validity of the capacity information which is acquired from the computation device 200 which is the target of the computation task request. If there is a case where the computation capacity is dishonestly overstated by the manager of the computation device 200 in an attempt to receive contracts for more of the computation tasks, the computation capacity which is shown by the capacity information input by the capacity information acquisition section 104 will be considerably larger than the computation capacity which is shown by the capacity information input by the computation capacity prediction section 103. That is, it is possible for the computation capacity verification section 105 to detect the declaration of dishonest computation capacity using the computation device 200.

The verification result using the computation capacity verification section 105 is notified to the task management section 106. In a case where the notified verification result shows dishonesty, the task management section 106 removes the computation device 200 which declared a dishonest computation capacity from the target for computation task request. Then, the task management section 106 selects the computation device 200 where execution of the computation task is actually requested from the computation devices 200 which have not been removed and still remain. At this time, the task management section 106 references the capacity information of each computation device 200 and selects the computation device 200 which is able to complete the computation task in a predetermined time. In a case where a plurality of computation devices 200 are selected with regard to one computation task, for example, for example, the computation device 200 which the highest computation capacity or the computation device 200 with the lowest computation cost is selected.

The task management section 106 allocates the computation task to the selected computation device 200. Then, the task management section 106 requests the execution of the allocated computation task to the computation device 200 which is the target via the communication section 101. Due to the request, the computation task is executed by the computation device 200 and the computation result is sent from the computation device 200. The computation result is received via the communication section 101 and input from the communication section 101 into the task management section 106.

Here, the task management section 106 measures the time from the requesting of the computation task execution to the reception of the computation result (below, computation execution time). In addition, the task management section 106 calculates the time which is necessary to complete the execution of the requested computation task based on the computation capacity of the computation device 200 and the computation amount of the computation task (below, prediction time). Then, the task management section 106 inputs the computation execution time and the prediction time to the dishonesty detection section 107. When the computation execution time and the prediction time are input, the dishonesty detection section 107 detects a dishonest computation result based on the input computation execution time and the prediction time. For example, the dishonesty detection section 107 compares the computation execution time and the prediction time and it is determined that the computation result is dishonest in a case where the computation execution time is shorter than the prediction time.

The detection result using the dishonesty detection section 107 is notified to the task management section 106. In a case where the notified detection result shows dishonesty, for example, the task management section 106 removes the computation device 200 which returned the computation result which is determined to be dishonest from the computation task allocation target hereinafter. In this manner, it is possible to detect the computation device 200 which returns the haphazard computation result by detecting the dishonest computation results and it is possible to prevent the paying of a price for dishonest computation and the reliability of the computations being damaged.

Above, the function configuration of the task management system 100 has been described.

[1-3: Functional Configuration of Computation Device 200]

Next, the functional configuration of the computation device 200 will be described while referencing FIG. 3. FIG. 3 is an explanatory diagram for describing the functional configuration of the computation device 200. Here, the functional configuration of the computation device 200 shown in FIG. 3 is one example and appropriate omissions and modifications of a portion of the constituent elements are possible in regard to the method of allocating a computation task which will be described later.

As shown in FIG. 3, the computation device 200 is mainly configured by a communication section 201, a weather information acquisition section 202, a computation capacity prediction section 203, and a computation execution section 204.

The communication section 201 is a communication unit for communicating via the network 50. As described above, when requesting a computation task, first, the task management system 100 inquiries about the computation capacity with regard to the computation device 200. When an inquiry is received, the weather information acquisition section 202 acquires weather information of a time when the execution of the computation task is scheduled via the communication section 201. Then, the weather information which is acquired by the weather information acquisition section 202 is input to the computation capacity prediction section 203. When the weather information is input, the computation capacity prediction section 203 predicts the computation capacity during the execution of the computation task based on the input weather information.

Here, the computation capacity prediction section 203 already holds information such as that related to the computation amount which is able to be executed per unit of time by the computation device 200 using the electrical power of the electrical power amount P (below, computation performance information). In addition, the computation capacity prediction section 203 already holds information related to generation performance of a power generator (power generator which generates electrical power derived from renewable energy) for supplying electrical power to the computation device 200 (below, generation performance information). As a result, the computation capacity prediction section 203 predicts the electrical power amount P which is supplied with regard to the computation device 200 in a computation task execution scheduling period using the weather information and the generation capacity information and predicts the computation capacity using the prediction result and the computation performance information. The capacity information which shows the computation capacity predicted by the computation capacity prediction section 203 is sent to the task management system 100 via the communication section 201.

In addition, in a case where the execution of the computation task is received from the task management system 100, the computation task which is sent from the task management system 100 is input into the computation execution section 204 via the communication section 201. When the computation task is input, the computation execution section 204 executes the input computation task. When the execution of the computation task is finished, the computation execution section 204 outputs the execution result of the computation task (below, computation result). The computation result output by the computation execution section 204 is sent to the task management system 100 via the communication section 201.

Above, the functional configuration of the computation device 200 has been described.

[1-4: Task Allocation Method]

Next, a task allocation method according to the embodiment will be described with specific examples.

(1-4-1: Case where Computation Capacity is Predicted Using Task Management System 100)

First, a method of appropriately allocating a computation task using information relating to the computation capacity of the computation device 200 which is predicted by the task management system 100 will be described while referencing FIG. 4. FIG. 4 is an explanatory diagram for describing a method of appropriately allocating a computation task using information relating to the computation capacity of the computation device 200 which is predicted by the task management system 100. Here, the exchanges between the task management system 100 and one computation device 200 is described in FIG. 4, but in practice, the same exchanges are executed with regard to a plurality of computation devices 200.

As shown in FIG. 4, first, the task management system 100 acquires the environment information from the computation device 200 and holds (registers) the acquired environment information (S100). The environment information referred to here is information such as computation performance information described above which relates to the computation performance of the computation device 200, generation performance information described above which relates to generation performance of a generator which supplies electric power to the computation device 200, and the like. By registering the environment information in advance in the task management system 100, it is possible for the computation performance of the computation device 200 to be predicted in the task management system 100. Here, the registering process of the environment information shown in step S100 may not be performed every time a computation task is allocated.

When the registering process of the environment information is completed, the task management system 100 predicts the computation capacity of the computation device 200 during the execution of the computation task based on a weather forecast (S101). First, the task management system 100 acquires weather information from the weather information provision service 70 using the function of the weather information acquisition section 102. The weather information is weather information of a region where the computation device 200 is disposed. In addition, the weather information is a weather forecast which shows the conditions of the weather in the time when the execution of the computation task is scheduled. When the weather information is acquired, the task management system 100 predicts the amount of electrical power which is supplied to the computation device 200 based on the acquired weather information using the function of the computation capacity prediction section 103. Then, the task management system 100 calculates the computation capacity of the computation device 200 from the predicted amount of electrical power using the function of the computation capacity prediction section 103.

When the computation capacity prediction process is completed, the task management system 100 inquires about whether or not the execution of the computation task is possible to the computation device 200 using the function of the task management section 106 (S102). At this time, the task management system 100 notifies the computation device 200 of the computation amount of the computation task and the desired execution time (or completion timing) of the computation task using the function of the task management section 106. In regard to the inquiry, the computation device 200 responds with whether or not the execution of the computation task is possible (S103). For example, in a case such as where a computation task other than the computation task for which an inquiry has been received is being executed, the computation device 200 responses that the execution of the computation task is not possible in a case where it is difficult to complete the computation task for which an inquiry has been received in the desired computation task execution time. However, here, the description will progress with the response that the execution of the computation task is possible.

When the response is received from the computation device 200, the task management system 100 allocates the computation task with regard to the computation device 200 using the function of the task management section 106. Then, the task management system 100 requests the execution of the allocated computation task to the computation device 200 using the function of the task management section 106 (S104). As this time, the task management system 100 allocates the computation task using the task management section 106 based on the computation capacity predicted in step S101. For example, in a case where the computation task execution time, which is calculated based on the computation amount of the computation task which is to be executed and the computation capacity, is shorter than the desired computation task execution time, the task management system 100 allocates the computation task to the computation device 200 using the function of the task management section 106.

Here, in practice, the task management system 100 executes the computation task allocation method with a plurality of computation devices 200 as the request targets. As a result, the plurality of computation devices 200 may be considered as request target candidates with regard to the same computation task. In a case where the plurality of computation devices 200 are request target candidates with regard to the same computation task, the task management system 100 narrows down the computation devices 200 which are the request targets based on the computation capacity of each computation device 200 using the function of the task management section 106. For example, the task management system 100 selects the computation device 200 with the highest computation capacity as the computation device 200 which is the request target using the function of the task management section 106. When there is a configuration such as this, there is a high possibility that it is possible to complete the computation task in the desired computation task execution time.

When the execution of the computation task is requested to the computation device 200, the computation device 200 executes the requested computation task using the function of the computation execution section 204. Then, when the computation task is completed, the computation device 200 notifies the task management system 100 of the computation result (S105).

Above, a method of appropriately allocating a computation task using information relating to the computation capacity of the computation device 200 which is predicted by the task management system 100 has been described. In the case of applying the method, it is possible to omit the weather information acquisition section 202 and the computation capacity prediction section 203 which are included in the computation device 200. In addition, here, the exchanges between the task management system 100 and the computation device 200 have been shown by focusing on one computation device 200, but in practice, the same exchanges are executed with regard to a plurality of computation devices 200.

(1-4-2: Case where Computation Capacity is Predicted Using Computation Device 200)

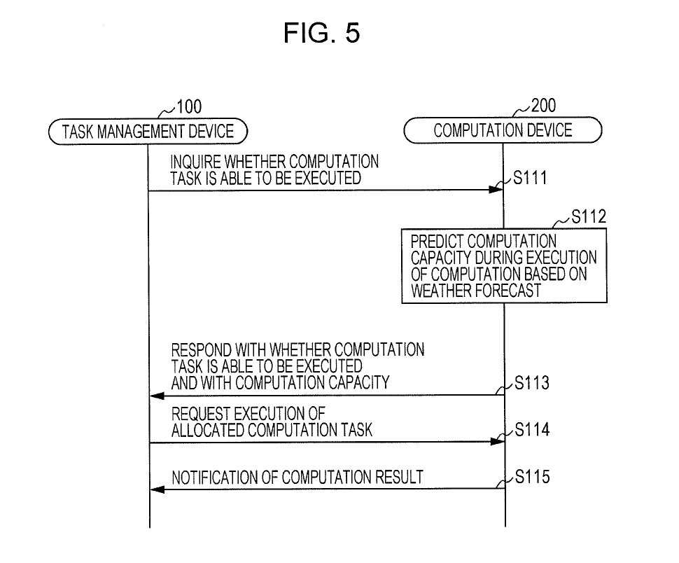

Next, a method of appropriately allocating a computation task using information relating to the computation capacity during the execution of the computation task which is predicted by the computation device 200 will be described while referencing FIG. 5. FIG. 5 is an explanatory diagram for describing a method of appropriately allocating a computation task using information relating to the computation capacity during the execution of the computation task which is predicted by the computation device 200. Here, the exchanges between the task management system 100 and one computation device 200 is described in FIG. 5, but in practice, the same exchanges are executed with regard to a plurality of computation devices 200.

As shown in FIG. 5, first, the task management system 100 inquires about whether or not the execution of the computation task is possible to the computation device 200 using the function of the task management section 106 (S111). At this time, the task management system 100 notifies the computation device 200 of the computation amount of the computation task and the desired execution time (or completion timing) of the computation task using the function of the task management section 106. In regard to the inquiry, the computation device 200 predicts the computation capacity during the execution of the computation task based on a weather forecast (S112).

First, the computation device 200 acquires weather information from the weather information provision service 70 using the function of the weather information acquisition section 202. The weather information is weather information of a region where the computation device 200 is disposed. In addition, the weather information is a weather forecast which shows the conditions of the weather in the time when the execution of the computation task is scheduled. When the weather information is acquired, the computation device 200 predicts the amount of electrical power which is supplied during the execution of the computation task based on the acquired weather information using the function of the computation capacity prediction section 203. Then, the computation device 200 calculates the computation capacity of the computation device 200 from the predicted amount of electrical power using the function of the computation capacity prediction section 203.

When the computation capacity prediction process is completed, the computation device 200 responses with whether or not execution of the computation task is possible and with the predicted computation capacity to the task management system 100 (S113). For example, in a case such as where a computation task other than the computation task for which an inquiry has been received is being executed, the computation device 200 responses that the execution of the computation task is not possible in a case where it is difficult to complete the computation task for which an inquiry has been received in the desired computation task execution time. In addition, the computation device 200 responses that the execution of the computation task is not possible in a case where it is difficult to carry out the computation task in the desired computation task execution time with the predicted computation capacity. However, here, the description will progress with the response that the execution of the computation task is possible.

When the response is received from the computation device 200, the task management system 100 allocates the computation task with regard to the computation device 200 using the function of the task management section 106. Then, the task management system 100 requests the execution of the allocated computation task to the computation device 200 using the function of the task management section 106 (S114). As this time, the task management system 100 allocates the computation task using the task management section 106 based on the computation capacity predicted by the computation device 200. For example, in a case where the computation task execution time, which is calculated based on the computation amount of the computation task which is to be executed and the computation capacity, is shorter than the desired computation task execution time, the task management system 100 allocates the computation task to the computation device 200 using the function of the task management section 106.

Here, in practice, the task management system 100 executes the computation task allocation method with a plurality of computation devices 200 as the request targets. As a result, the plurality of computation devices 200 may be considered as request target candidates with regard to the same computation task. In a case where the plurality of computation devices 200 are request target candidates with regard to the same computation task, the task management system 100 narrows down the computation devices 200 which are the request targets based on the computation capacity of each computation device 200 using the function of the task management section 106. For example, the task management system 100 selects the computation device 200 with the highest computation capacity as the computation device 200 which is the request target using the function of the task management section 106. When there is a configuration such as this, there is a high possibility that it is possible to complete the computation task in the desired computation task execution time.

When the execution of the computation task is requested to the computation device 200, the computation device 200 executes the requested computation task using the function of the computation execution section 204. Then, when the computation task is completed, the computation device 200 notifies the task management system 100 of the computation result (S115).

Above, a method of appropriately allocating a computation task using information relating to the computation capacity during the execution of the computation task which is predicted by the computation device 200 has been described. Here, the exchanges between the task management system 100 and the computation device 200 have been shown by focusing on one computation device 200, but in practice, the same exchanges are executed with regard to a plurality of computation devices 200.

(1-4-3: Case where Computation Capacity is Verified)

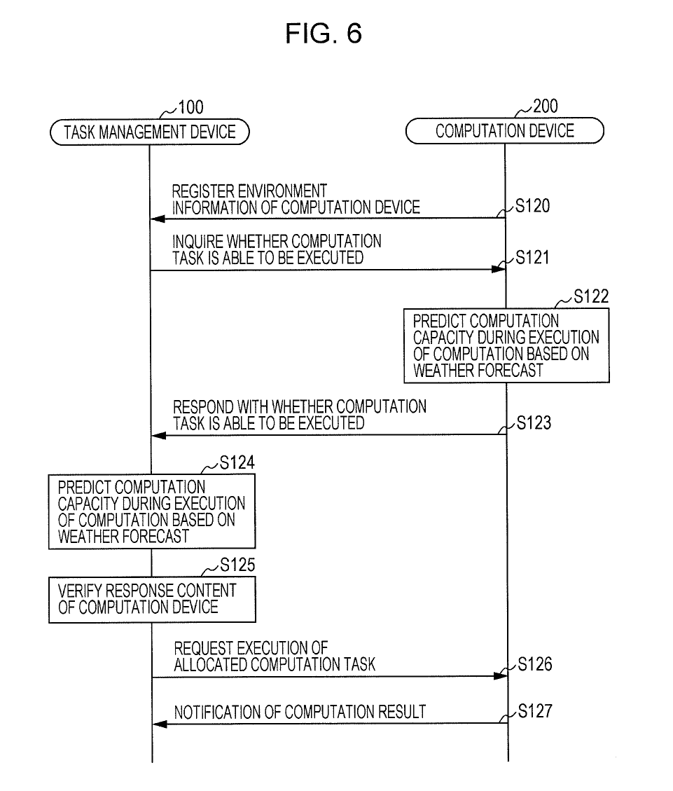

Next, a task allocation method, which includes a process where accuracy of a response of the computation device 200 with regard to an inquiry of the task management system 100 is verified, will be described while referencing FIG. 6. FIG. 6 is an explanatory diagram for describing a task allocation method which includes a process where accuracy of a response of the computation device 200 with regard to an inquiry of the task management system 100 is verified. Here, the exchanges between the task management system 100 and one computation device 200 is described in FIG. 6, but in practice, the same exchanges are executed with regard to a plurality of computation devices 200.

As shown in FIG. 6, first, the task management system 100 acquires the environment information from the computation device 200 and holds (registers) the acquired environment information (S120). The environment information referred to here is information such as computation performance information described above which relates to the computation performance of the computation device 200, generation performance information described above which relates to generation performance of a generator which supplies electric power to the computation device 200, and the like. By registering the environment information in advance in the task management system 100, it is possible for the computation performance of the computation device 200 to be predicted in the task management system 100. Here, the registering process of the environment information shown in step S120 may not be performed every time a computation task is allocated.

Next, the task management system 100 inquires about whether or not the execution of the computation task is possible to the computation device 200 using the function of the task management section 106 (S121). At this time, the task management system 100 notifies the computation device 200 of the computation amount of the computation task and the desired execution time (or completion timing) of the computation task using the function of the task management section 106. In regard to the inquiry, the computation device 200 predicts the computation capacity during the execution of the computation task based on a weather forecast (S122).

First, the computation device 200 acquires weather information from the weather information provision service 70 using the function of the weather information acquisition section 202. The weather information is weather information of a region where the computation device 200 is disposed. In addition, the weather information is a weather forecast which shows the conditions of the weather in the time when the execution of the computation task is scheduled. When the weather information is acquired, the computation device 200 predicts the amount of electrical power which is supplied during the execution of the computation task based on the acquired weather information using the function of the computation capacity prediction section 203. Then, the computation device 200 calculates the computation capacity of the computation device 200 from the predicted amount of electrical power using the function of the computation capacity prediction section 203.

When the computation capacity prediction process is completed, the computation device 200 responses with whether or not execution of the computation task is possible and with the predicted computation capacity to the task management system 100 (S123). For example, in a case such as where a computation task other than the computation task for which an inquiry has been received is being executed, the computation device 200 responses that the execution of the computation task is not possible in a case where it is difficult to complete the computation task for which an inquiry has been received in the desired computation task execution time. In addition, the computation device 200 responses that the execution of the computation task is not possible in a case where it is difficult to carry out the computation task in the desired computation task execution time with the predicted computation capacity. However, here, the description will progress with the response that the execution of the computation task is possible.

When the response is received from the computation device 200, the task management system 100 predicts the computation capacity of the computation device 200 during the execution of the computation task based on a weather forecast (S124). First, the task management system 100 acquires weather information from the weather information provision service 70 using the function of the weather information acquisition section 102. The weather information is weather information of a region where the computation device 200 is disposed. In addition, the weather information is a weather forecast which shows the conditions of the weather in the time when the execution of the computation task is scheduled. When the weather information is acquired, the task management system 100 predicts the amount of electrical power which is supplied to the computation device 200 based on the acquired weather information using the function of the computation capacity prediction section 103. Then, the task management system 100 calculates the computation capacity of the computation device 200 from the predicted amount of electrical power using the function of the computation capacity prediction section 103.

When the computation capacity prediction process is completed, the task management system 100 verifies the content of the response received from the computation device 200 using the function of the computation capacity verification section 105 (S125). For example, the task management system 100 compares the computation capacity in the response of the computation device 200 and the computation capacity which is predicted in step S124 and confirms whether or not the computation capacities are considerably different using the function of the computation capacity verification section 105. At this time, in a case where the computation capacities are considerably different, it may be considered that the response from the computation device 200 is dishonest. As a result, the computation device 200 which sent the response that is considered to be dishonest is, for example, removed from the computation task allocation target. When there is a configuration such as this, it is possible to remove the computation device 200 where dishonesty is suspected from the allocation target and it is possible to improve the reliability of the computation result.

In a case where the validity of the response content is confirmed in step S125, the task management system 100 allocates the computation task with regard to the computation device 200 using the function of the task management section 106. Then, the task management system 100 requests the execution of the allocated computation task to the computation device 200 using the function of the task management section 106 (S126). As this time, the task management system 100 allocates the computation task using the task management section 106 based on the computation capacity predicted in step S124. For example, in a case where the computation task execution time, which is calculated based on the computation amount of the computation task which is to be executed and the computation capacity, is shorter than the desired computation task execution time, the task management system 100 allocates the computation task to the computation device 200 using the function of the task management section 106.

Here, in practice, the task management system 100 executes the computation task allocation method with a plurality of computation devices 200 as the request targets. As a result, the plurality of computation devices 200 may be considered as request target candidates with regard to the same computation task. In a case where the plurality of computation devices 200 are request target candidates with regard to the same computation task, the task management system 100 narrows down the computation devices 200 which are the request targets based on the computation capacity of each computation device 200 using the function of the task management section 106. For example, the task management system 100 selects the computation device 200 with the highest computation capacity as the computation device 200 which is the request target using the function of the task management section 106. When there is a configuration such as this, there is a high possibility that it is possible to complete the computation task in the desired computation task execution time.

When the execution of the computation task is requested to the computation device 200, the computation device 200 executes the requested computation task using the function of the computation execution section 204. Then, when the computation task is completed, the computation device 200 notifies the task management system 100 of the computation result (S127).

Above, a task allocation method which includes a process where accuracy of a response of the computation device 200 with regard to an inquiry of the task management system 100 is verified has been described. Here, the exchanges between the task management system 100 and the computation device 200 have been shown by focusing on one computation device 200, but in practice, the same exchanges are executed with regard to a plurality of computation devices 200.

(Supplementary Description 1: Method of Verifying Response Content)

Here, description of the verifying method with regard to the response of the computation device 200 (equivalent to step S125 described above) will be supplemented while referencing FIGS. 8 to 10.

As shown in FIG. 8, when the execution start timing of the computation task is set as T1 and the execution completion timing of the computation task is set as T2, the computation execution time (T1˜T2) is in the future compared to the timing (current point in time) when the computation capacity is being predicted. It is possible to predict the computation capacity in the future using the weather forecast of the region where the computation device 200 is disposed. First, the generation amount is predicted based on the weather forecast and it is possible to predict the computation capacity using the prediction result and the computation performance of the computation device 200. Here, it is possible to express the computation capacity as the shortest time which is necessary to complete the computation task in a case where the execution of the computation task which has a certain computation amount starts at the timing T1.

Here, the computation capacity (prediction time ΔTexp) is predicted in the task management system 100. In addition, the computation capacity (response time ΔT) is notified to the task management system 100 as the response from the computation device 200. In this case, the task management system 100 verifies the response content of the computation device 200 by comparing the prediction time ΔTexp and the response time ΔT.

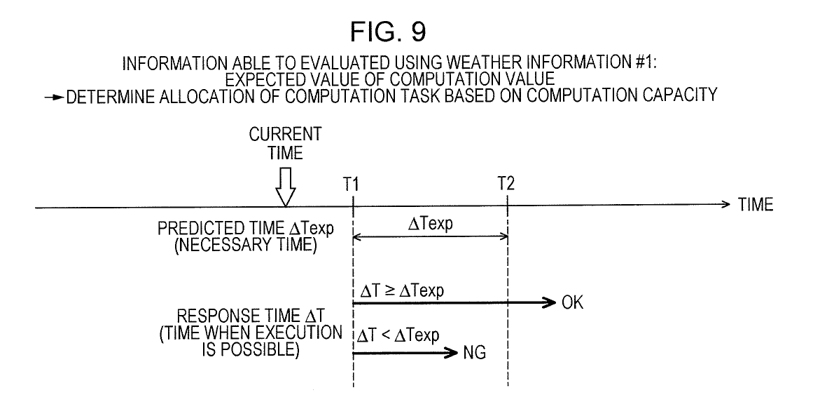

The aim of the manager of the computation device 200 carrying out dishonesty is to, for example, receive contracts for the computation tasks which exceed the computation capacity of the computation device 200 and to receive compensation only by returning haphazard computation results. As a result, the manager of the computation device 200 attempts to notify the task management system 100 with a response where the computation capacity (short response time ΔT) is higher than the actual computation device. Accordingly, as shown in FIG. 9, in a case where ΔT<ΔTexp, it is considered that the response of the computation device 200 is dishonest. On the other hand, in a case where ΔT≧ΔTexp, it is considered that the response of the computation device 200 is valid. Therefore, the task management system 100 allocates the computation task with regard to the computation device 200 in a case where ΔT≧ΔTexp.

However, there are cases where the storage battery 300 is connected to the computation device 200. In this case, it is possible for the computation device 200 to execute the computation task using the electrical power of the storage battery 300 which is expected to be stably output. As a result, the computation performance of the computation device 200 improves compared to a case of not being connected to the storage battery 300. However, the computation performance is different according to the amount of electrical power which is stored in the storage power 300. As a result, it is necessary to perform careful verification with regard to the response from the computation device 200 which is connected to the storage battery 300. In a case where the storage capacity of the storage battery 300 is understood, it is possible to predict the prediction time ΔTexp (x %) according to the storage amount of the storage battery 300 (prediction time in the case where x % of the electrical power is stored in the storage battery 300).

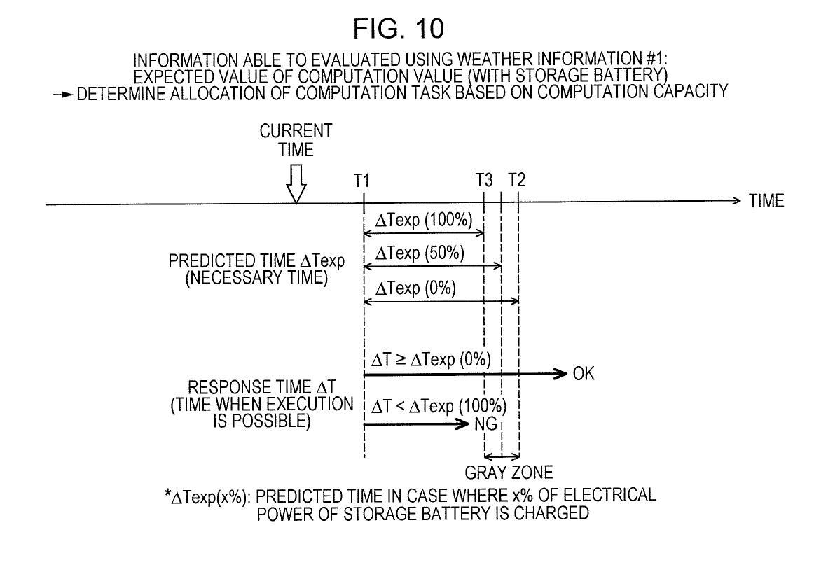

For example, as shown in FIG. 10, when the prediction time when the storage battery 300 is fully charged is expressed as ΔTexp(100%), the prediction time when the storage battery 300 is 50% charged is expressed as ΔTexp(50%), and the prediction time when the storage battery 300 is 0% charged is expressed as ΔTexp(0%), there is a relationship such that ΔTexp(100%)<ΔTexp(50%)<ΔTexp(0%). Therefore, the response time ΔT is compared to the shortest prediction time ΔTexp(100%) and it is considered that the response of the computation device 200 is dishonest in a case where ΔT<ΔTexp(100%). On the other hand, the response time ΔT is compared to the longest prediction time ΔTexp(0%) and it is considered that the response of the computation device 200 is valid in a case where ΔT≧ΔTexp(0%). However, in order to determine the validity of the response in a case where ΔTexp(100%)<ΔT<ΔTexp(0%), it is sufficient to determine the validity of the response based on a standard which is determined in advance by the manager of the task management system 100.

Above, the description of the verification method with regard to the response of the computation device 200 (equivalent to step S125 described above) has been supplemented. The verification method described above is one example, but it is possible to distinguish dishonesty in a case where the computation device 200 responds with a dishonest response using the method.

(Supplementary Description 2: Method of Estimating Storage Amount)

Here, the description of a method for predicting the storage amount of the storage battery 300 which is connected to the computation device 200 will be simply supplemented. In a case of a system where electrical power derived from renewable energy is supplied also with regard to the storage battery 300 which is connected to the computation device 200, it is possible to roughly estimate the storage amount of the storage battery 300 based on past weather information. The estimation method is the same in practice as the method of predicting the computation capacity described above, but the weather information which is used is different. The weather forecast is used in the predicting of the computation capacity. However, when predicting the storage amount of the storage battery 300, past weather information is used. That is, it is possible to roughly estimate the storage amount of the storage battery 300 by estimating the amount of electrical power which is supplied to the storage battery 300 before the start of the execution of the computation task based on past weather information.

It is possible to estimate with regard to the storage amount of the storage battery 300 using when the response content of the computation device 200 is verified or when the computation result is verified (which will be described later). For example, even if ΔTexp(100%)<ΔT<ΔTexp(80%), it is possible to consider that the response is valid if the storage battery 300 is estimated to be in a state of being close to fully charged. In this manner, it is possible to increase the verification accuracy by estimating the storage amount of the storage battery 300.

[1-5: Dishonesty Verification Method]

Next, a dishonesty verification method using the task management system 100 will be described while referencing FIG. 7. Until here, the validity of the computation capacity in the response from the computation device 200 has been dealt with. However, even if the response is correct in relation to the computation capacity, it is not possible to guarantee the validity of the computation result. For example, the manager of the computation device 200 who has negative intentions may respond with the correct computation capacity, be requested to execute the computation task, and respond with a haphazard computation result. Therefore, the present inventors propose a dishonesty verification method for verifying the validity of the computation result. Here, it is possible to combine the dishonesty verification method with the task allocation method shown in FIGS. 4 to 6.

First, the task allocation method shown in FIGS. 4 to 6 is executed and the execution of the allocated computation task is requested to the computation device 200 by the task management system 100 (S131). When the execution of the computation task is requested to the computation device 200, the computation device 200 executes the requested computation task using the function of the computation execution section 204. Then, when the computation task is completed, the computation device 200 notifies the task management system 100 of the computation result (S132). At this time, the task management system 100 measures the time (below, computation execution time ΔTr) from the request of the execution of the computation task to the notification of the computation result. Then, when the computation result is received, the task management system 100 verifies whether there is dishonesty (S133).

First, the task management system 100 predicts the time (prediction time ΔTexp) which is necessary to execute the computation task based on the computation capacity of the computation device 200 and the computation amount of the computation task using the function of the dishonesty detection section 107. Next, the task management system 100 compares the prediction time ΔTexp and the computation execution time ΔTr using the function of the dishonesty detection section 107. The manager of the computation device 200 which has negative intentions attempts to receive contracts for more of the computation task than the number of the computation tasks which are possible to be actually executed using the computation device 200. As a result, it is considered that the dishonest computation result is returned in a shorter time than a case where the computation task is actually executed.

Therefore, the task management system 100 determines the computation result is dishonest in a case where ΔTr<ΔTexp as shown in FIG. 11 using the function of the dishonesty detection section 107. On the other hand, the task management system 100 determines the computation result is valid in a case where ΔTr≧ΔTexp using the function of the dishonesty detection section 107. In addition, in a case where the storage battery 300 is connected to the computation device 200, the computation execution time ΔTr is compared to the prediction times ΔTexp(100%) and ΔTexp(0%) in a case where the storage battery 300 is fully charged or a case where the storage battery 300 is 0% charged. Then, as shown in FIG. 12, the task management system 100 determines the computation result is dishonest in a case where ΔTr<ΔTexp(100%) using the function of the dishonesty detection section 107. On the other hand, the task management system 100 determines the computation result is valid in a case where ΔTr≧ΔTexp(0%) using the function of the dishonesty detection section 107.

Above, the dishonesty verification method using the task management system 100 has been described. It is possible to detect the dishonest computation devices 200 by applying the dishonest verification method. In addition, it is possible to increase the reliability of the computation result by removing the dishonest computation device 200 from the computation task allocation target.

[1-6: Hardware Configuration Example]

It is possible for the function of each constituent element which the task management system 100 and the computation device 200 described above have to be realized, for example, using the hardware configuration of the information processing device shown in FIG. 13. That is, the function of each constituent element is realized by the hardware shown in FIG. 13 being controlled using a computer program. Here, the format of the hardware is arbitrary, and for example, a personal computer, a mobile phone, a PHS, a mobile information terminal such as a PDA, a game device, and various information appliances are included in this. Here, PHS is an abbreviation for Personal Handy-phone System. In addition, PDA is an abbreviation for Personal Digital Assistant.

As shown in FIG. 13, the hardware mainly has a CPU 902, a ROM 904, a RAM 906, a host bus 908, and a bridge 910. Furthermore, the hardware has an external bus 912, an interface 914, an input section 916, an output section 918, a storage section 920, a driver 922, a connection port 924, and a communication section 926. Here, CPU is an abbreviation for Central Processing Unit. In addition, ROM is an abbreviation for Read Only Memory. Also, RAM is an abbreviation for Random Access Memory.

The CPU 902 functions as, for example, a computation processing device or control device and controls all of or a portion of the operations of each constituent element based on various programs which are recorded in the ROM 904, the RAM 906, the storage section 920, or a removable recording medium 928. The ROM 904 is a unit for storing programs which are read out to the CPU 902, data used in computation, and the like. The RAM 906 temporarily or permanently stores, for example, programs which are read out to the CPU 902, various parameters which are arbitrarily changed when executing the programs, and the like.

These constituent elements are, for example, connected to each other via the host bus 908 where high-speed data transfer is possible. On the other hand, the host bus 908 is, for example, connected to an external bus 912 where the data transfer speed is relatively low via the bridge 910. In addition, as the input section 916, for example, a mouse, a keyboard, a touch panel, a button, a switch, a lever, or the like are able to be used. Furthermore, as the input section 916, it is possible to use a remote controller which is able to transmit a control signal using infrared or other waves.

The output section 918 is, for example, a device which is able to notify a user of acquired information visually or using sound such as a display device such as a CRT, LCD, PDP, or ELD, an audio output device such as a speaker or headphones, a printer, a mobile phone, a facsimile, or the like. Here, CRT is an abbreviation for Cathode Ray Tube. In addition, LCD is an abbreviation for Liquid Crystal Display. Also, PDP is an abbreviation for Plasma Display Panel. Furthermore, ELD is an abbreviation for Electro-Luminescence Display.

The storage device 920 is a device for storing various types of data. As the storage device 920, for example, a magnetic storage device such as a hard disk drive (HDD), a semiconductor storage device, an optical storage device, a magneto-optical storage device, and the like are used. Here, HDD is an abbreviation for Hard Disk Drive.

The drive 922 is, for example, a device which reads out information recorded in the removable recording medium 928 such as a magnetic disc, an optical disc, a magneto-optical disc, or a semiconductor memory and writes information into the removable recording medium 928. The removable recording medium 928 is, for example, a DVD medium, a Blu-ray medium, an HD DVD medium, various types of semiconductor storage media, and the like. Of course, the removable recording medium 928 may be an IC card which is mounted with a non-contact type IC chip, an electronic apparatus, or the like. Here, IC is an abbreviation for Integrated Circuit.

The connection port 924 is, for example, a port for connecting an external connection device 930 such as a USB port, an IEEE 1394 port, a SCSI, a RS-232C port, or an optical audio terminal. The external connection device 930 is, for example, a printer, a portable music player, a digital camera, a digital video camera, an IC recorder, or the like. Here, USB is an abbreviation for Universal Serial Bus. In addition, SCSI is an abbreviation for Small Computer System Interface.

The communication section 926 is a communication device for connecting to a network 932, and is, for example, a wired or wireless LAN, Bluetooth (registered trademark), a WUSB IC card, an optical communication router, an ADSL router, various types of communication modems, or the like. In addition, the network 932 to which the communication section 926 is connected is configured using a network which is connected in a wired or wireless manner, and is, for example, the Internet, a household LAN, infrared communication, visible light communication, broadcasting or satellite communication, or the like. Here, LAN is an abbreviation for Local Area Network. In addition, WUSB is an abbreviation for Wireless USB. Also, ADSL is an abbreviation for Asymmetric Digital Subscriber Line.

### 2. Summary

Lastly, the technical concept of the embodiment of the disclosure will be simply summarized. The technical concept written here is able to be applied to, for example, various information processing devices such as a PC, a mobile phone, a portable game device, a mobile information terminal, an information appliance, or a car navigation system. For example, it is possible to realize the function of the task management system described above using an information processing device such as a high-performance PC. In addition, it is possible to realize the function of the computation device described above using an information processing device such as a PC, a mobile phone, a portable game device, a mobile information terminal, an information appliance, or a car navigation system.

It is possible to express the task management system according to the embodiment as follows. The task management system has a capacity information acquisition section and a task management section as follows. The capacity information acquisition section acquires capacity information which shows the computation capacity of a computation device, which is predicted based on weather information of a region where the computation device is disposed, from the computation device which executes a computation using electrical power derived from renewable energy. In addition, the task management section allocates a computation task to a plurality of computation devices based on the capacity information acquired from the plurality of computation devices using the capacity information acquisition section.

It is possible for the task management section to know the computation capacity of each of the computation devices during execution of a computation by having the capacity information acquisition section. For example, when the weather information is used, it is possible to predict the generation amount of electrical power derived from renewable energy during the execution of a computation (from a computation start schedule timing until after a predetermined time has passed). When the generation amount of electrical power is known, it is possible to evaluate the computation capacity of the computation device during the execution of a computation task by multiplying the computation amount which is able to be executed by the computation device per unit of electrical power with the generation amount. When the computation capacity is able to be evaluated in this manner, it is possible to extract the computation device which is expected to be able to complete the computation task using the evaluation result.

That is, in a case where the computation amount of a certain computation task does not exceed the computation capacity which a certain computation device has during execution, the computation task may be allocated to the computation device. On the other hand, in a case where the computation amount of a certain computation task exceeds the computation capacity which a certain computation device has during execution, the computation device may be removed from the computation task allocation target. By repeating a process such as this, it is possible to allocate a computation task which is to be executed to an appropriate computation device. That is, it is possible to prevent a remarkable reduction in the overall system performance due to a considerable delay in the execution of a computation task by a portion of the computation devices.

(Note)

The task management section 106 is one example of a computation request section and a result acquisition section.

Above, a suitable embodiment of the disclosure has been described with reference to the attached diagrams, but it is needless to say that the disclosure is not limited by this example. It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2010-279662 filed in the Japan Patent Office on Dec. 15, 2010, the entire contents of which are hereby incorporated by reference.

What is claimed is:

1. A task management system comprising:
a capacity information acquisition section which acquires, from a computation device which executes a computation using electrical power derived from renewable energy, capacity information which shows computation capacity of the computation device which is predicted based on weather information of a region where the computation device is disposed; and
a task management section which allocates a computation task to a plurality of the computation devices based on the capacity information which is acquired from the plurality of computation devices using the capacity information acquisition section.

2. The task management system according to claim 1, further comprising:
a computation capacity prediction section which predicts the computation capacity of the computation device based on weather information of the region where the computation device is disposed; and
a computation capacity verification section which verifies the validity of the capacity information by comparing the computation capacity shown in the capacity information acquired by the capacity information acquisition section and the computation capacity predicted by the computation capacity prediction section,
wherein the task management section allocates the computation task to the computation device which corresponds to the capacity information where the validity is confirmed by the computation capacity verification section.

3. A task management system comprising:
a computation capacity prediction section which predicts computation capacity of a computation device, which executes a computation using electrical power derived from renewable energy, from weather information of a region where the computation device is disposed; and
a task management section which allocates a computation task to a plurality of the computation devices based on the computation capacity which is predicted by the computation capacity prediction section with regard to the plurality of computation devices.

4. The task management system according to claim 2, further comprising:
an execution request section which requests execution of the computation task with regard to the computation device which is allocated the computation task by the task management section;
a result acquisition section which acquires an execution result of the computation task from the computation device which received the request for the computation task using the execution request section; and
a dishonesty detection section which detects dishonesty in the execution result which is acquired by the result acquisition section based on information on the computation capacity which is predicted by the computation capacity prediction section.

5. The task management system according to claim 4,
wherein the dishonesty detection section determines that the execution result which is acquired by the result acquisition section is dishonest in a case where a time T1, which is necessary until the computation task is completed in a case where the computation task is executed at the computation capacity which is predicted using the computation capacity prediction section, and a time T2, which it has taken from the execution request using the execution request section until the execution result is acquired using the result acquisition section, are compared and T2<T1.

6. The task management system according to claim 5,
wherein, in a case where the computation device where the execution of the computation task is requested by the execution request section is connected to a storage battery, the dishonesty detection section determines that the execution result which is acquired by the result acquisition section is dishonest in a case where a time T3, which is necessary until the computation task is completed in a case where the computation task is executed using the computation capacity of the computation device in a state where the storage battery is fully charged and the computation capacity which is predicted by the computation capacity prediction section, and a time T2 which it has taken from the execution request using the execution request section until the execution result is acquired using the result acquisition section, are compared and T2<T3.

7. A task management method of a task management system comprising:
acquiring, from a computation device which executes a computation using electrical power derived from renewable energy, capacity information which shows computation capacity of the computation device which is predicted based on weather information of a region where the computation device is disposed; and
allocating a computation task to a plurality of the computation devices based on the capacity information which is acquired from the plurality of computation devices using the capacity information acquisition section.

8. A task management method of a task management system comprising:
predicting computation capacity of a computation device which executes a computation using electrical power derived from renewable energy from weather information of a region where the computation device is disposed; and
allocating a computation task to a plurality of the computation devices based on the computation capacity which is predicted with regard to the plurality of computation devices.

9. A program which causes a computer to execute:
a capacity information acquisition function which acquires, from a computation device which executes a computation using electrical power derived from renewable energy, capacity information which shows computation capacity of the computation device which is predicted based on weather information of a region where the computation device is disposed; and
a task management function which allocates a computation task to a plurality of the computation devices based on the capacity information which is acquired from the plurality of computation devices using the capacity information acquisition function.

10. A program which causes a computer to execute:
a computation capacity prediction function which predicts computation capacity of a computation device which executes a computation using electrical power derived from renewable energy from weather information of a region where the computation device is disposed; and
a task management function which allocates a computation task to a plurality of the computation devices based on the computation capacity which is predicted by the computation capacity prediction function with regard to the plurality of computation devices.
